(19) United States
(12) Patent Application Publication
(10) Pub. No.: US 2011/0006187 A1
(43) Pub. Date: Jan. 13, 2011

(54) METHOD OF FORMING A KNIFE MOLD BY ETCHING ONCE AND THE KNIFE MOLD FORMED BY THE METHOD

(75) Inventor: Lai Chu Tsai, Yilan County (TW)

Correspondence Address: LAW OFFICES OF MIKIO ISHIMARU, 333 W. EL CAMINO REAL, SUITE 330, SUNNYVALE, CA, 94087, US

(73) Assignee: Lai Chu Tsai, Yilan County (TW)

(21) Appl. No.: 12/550,071

(22) Filed: Aug. 28, 2009

(30) Foreign Application Priority Data
Jul. 7, 2009 (TW) 098122864

(51) Int. Cl. B28B 7/04; B44C 1/22

(52) U.S. Cl. 249/98; 216/41

(57) ABSTRACT

A method of forming a knife mold by etching once is provided. The method includes: providing a metal board; forming two corrosion-resistant photoresist layers on the metal board, and exposing and developing the corrosion-resistant photoresist layers, to form patterned lines on the metal board; spraying an etchant toward the metal board to etch the surface thereof, so as to form the blade; and removing the corrosion-resistant photoresist layers. The blade thus formed requires no further grinding or polishing and need not be etched a second time. The knife mold thus formed is well-defined and has a reduced knife edge tolerance and an increased conforming rate.

### BACKGROUND OF THE INVENTION

1. Field of the Invention

This invention relates to a method of forming a knife mold by using an etching technique, and more particularly, to a method of forming a knife mold by etching once.

2. Description of Related Art

An etch knife mold is primarily applied to the cutting of a material sheet, such as paper, film, foamed plastic, soft magnetic sheets, pictures, skin, and cloth, to form a specific pattern or letter, or to impress an embossed pattern or letter on a sheet surface, and is applied to the fabrication of a card, photo album and package material.

In general, there are two types of methods of fabricating the etch knife mold. According to the first one of the methods, a layer of acid-resistant ink line is printed on a surface of a metal board based on a desired pattern or letter, to divide the surface of the metal board into an etching area where no ink is printed and a non-etching area where the ink is printed; after the ink is dried, the metal board is immersed in an etchant, and the etching area is etched to form a concave portion, while the non-etching area is not etched to form a convex portion, as compared with the concave portion; and the convex portion is grinded by a grinding machine or a milling machine to form a blade. When the metal board is immersed in the etchant, if the ink line is not wide enough, the ink is easily to be collapsed and is less delicate. Further, the method is limited to the size of the grinding machine, cannot fabricate a detailed pattern, and has a very complicated fabrication process.

U.S. Pat. No. 3,850,059 and Taiwan Patent No. 27573 disclosed an etching method that etches a surface of a metal board by spraying an etchant. According to the method, the surface of the metal board is etched to form a blade prototype; and after ink or a photoresist layer is removed, the blade prototype is etched a second time, to form a blade sharp enough to cut paper. Collapse of the ink or photoresist layer is likely to occur because of pressure of the spraying of the etchant and impact of side-etch; hence, well-defined ink or photoresist layers are difficult to etch. In order to form a blade that is sharp enough to cut paper, the blade prototype has to be etched a second time after the ink or the photoresist layer is removed. However, the second time of the etching erodes a top portion of the blade, resulting in the unevenness of the height of the blade and degradation of the cutting effect. The method has other problems. For example, the method cannot overcome the water resistance effect due to the residual etchant, and the connection portion between the blade and knife mold stand is affected by bottom-etch, which leads to a low yield of a well-defined knife mold product.

Therefore, it is imperative to provide a method for fabricating a well-defined knife mold and overcome etchant-induced side erosion and water resistance.

### SUMMARY OF THE INVENTION

The present invention provides a method of forming a knife mold by etching once. The method includes the steps of: (A) providing a metal board having a first surface for forming a blade and a second surface opposite to the first surface; (B) forming a first corrosion-resistant photoresist layer on the first surface of the metal board, and exposing and developing the first corrosion-resistant photoresist layer, to form a patterned first line on the first surface; (C) forming on the first surface of the metal board a second corrosion-resistant photoresist layer for enclosing the first line, and forming on the second corrosion-resistant photoresist layer a patterned second line for enclosing the first line; (D) spraying an etchant toward the first surface of the metal board to etch the first surface of the metal board, so as to form the blade; and (E) removing the first corrosion-resistant photoresist layer and the second corrosion-resistant photoresist layer. The method of the present invention involves using two corrosion-resistant photoresist layers for being etched to form a blade, and then forming a well-defined knife mold without grinding or polishing the blade thus formed or etching the blade thus formed a second time, thereby decreasing the tolerance of the knife edge of the knife mold and increasing the conforming rate of the knife mold.

The present invention further provides a knife mold formed by etching once. The knife mold includes a knife mold stand and a blade formed on the knife mold stand, wherein a surface of a top end of the blade is made of the same metal as the knife mold stand and has the same pattern as a surface of the knife mold stand.

### BRIEF DESCRIPTION OF DRAWINGS

FIG. 1 is a flow chart of a method of forming a knife mold by etching once according to the present invention;

FIGS. 2A to 2G show a knife mold formed by a method of a first embodiment according to the present invention;

FIGS. 3A to 3G show a knife mold formed by a method of a second embodiment according to the present invention;

FIGS. 4A to 4G show a knife mold formed by a method of a third embodiment according to the present invention;

FIG. 5 is a top view of the knife mold formed by the method of the third embodiment according to the present invention;

FIGS. 6A to 6G show a knife mold formed by a method of a fourth embodiment according to the present invention;

FIG. 7 is a top view of the knife mold formed by the method of the fourth embodiment according to the present invention;

FIGS. 8A and 8B show a knife mold formed by a method according to the present invention;

FIGS. 9A to 9C show a knife mold set configured to be displaceable and reassembable and formed by a method according to the present invention; and

FIGS. 10A and 10B show a knife mold set formed by a method according to the present invention.

### DETAILED DESCRIPTION OF PREFERRED EMBODIMENTS

The following illustrative embodiments are provided to illustrate the disclosure of the present invention, these and other advantages and effects can be apparently understood by those skilled in the art after reading the disclosure of this specification. The present invention can also be performed or applied by other different embodiments. The details of the specification may be on the basis of different points and applications, and numerous modifications and variations can be devised without departing from the spirit of the present invention.

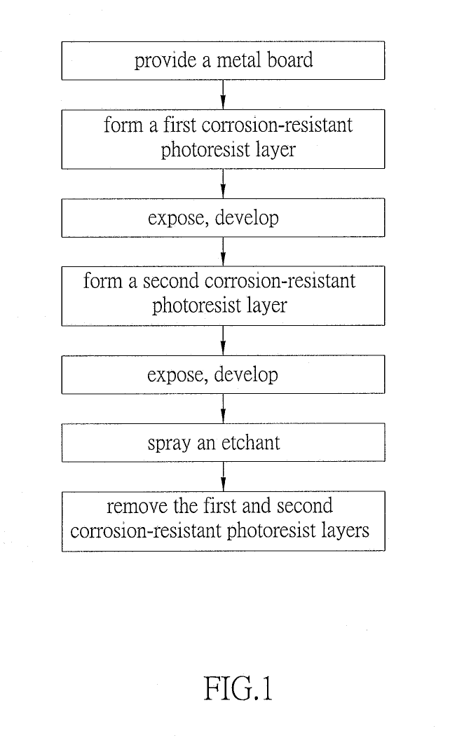

FIG. 1 is a flow chart of a method of forming a knife mold by etching once according to the present invention. The method includes (a) providing a metal board; (b1) forming a first corrosion-resistant photoresist layer on a surface of the metal board; (b2) exposing and developing the first corrosion-resistant photoresist layer with a negative having a specific pattern or letter, to form a patterned first line on the surface of the metal board; (c1) forming on the surface of the metal board a second corrosion-resistant photoresist layer for covering the first line; (c2) exposing and developing the second corrosion-resistant photoresist layer with a negative having a specific pattern or letter, to form on the surface of the metal board a patterned second line that encloses the first line, or (c1′ and c2′) printing on the second corrosion-resistant photoresist layer directly to form the patterned second line that encloses the first line; (d) spraying an etchant toward the surface of the metal board; and (e) removing the first and second corrosion-resistant photoresist layers from the surface of the metal board. In an embodiment of the present invention, the first and second corrosion-resistant photoresist layers may be formed by covering or printing themselves on the surface of the metal board, or by sticking a dry film on the surface of the metal board. In another embodiment of the present invention, the surface of the metal board is degreased and defatted prior to the formation of the first and second corrosion-resistant photoresist layers. After the first and second corrosion-resistant photoresist layers are removed, an antioxidation process is performed on the surface of the metal board, so as prevent the formed blade of the knife mold blade from being oxidized and thereby blunt.

### First Embodiment

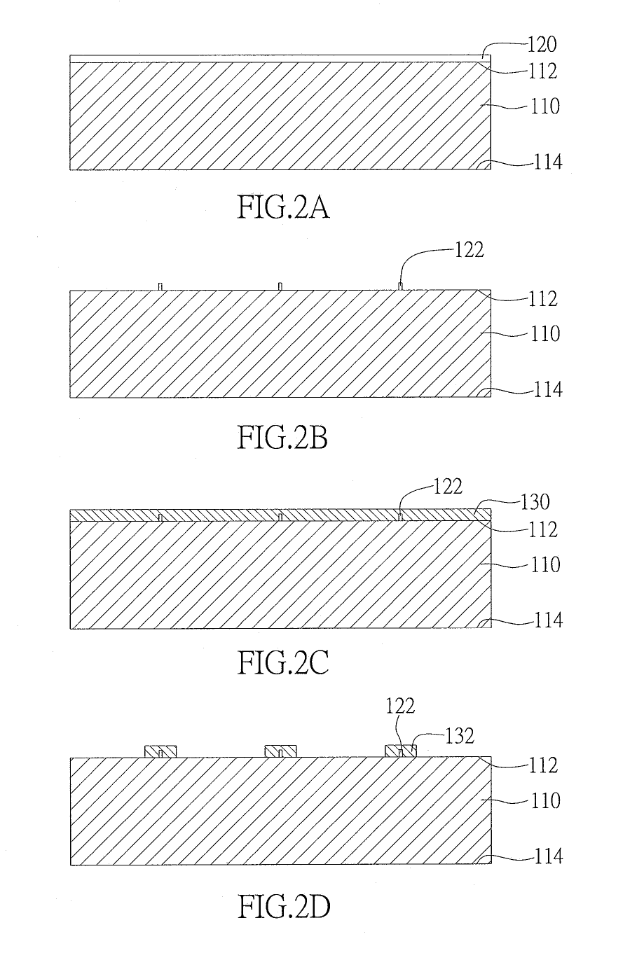

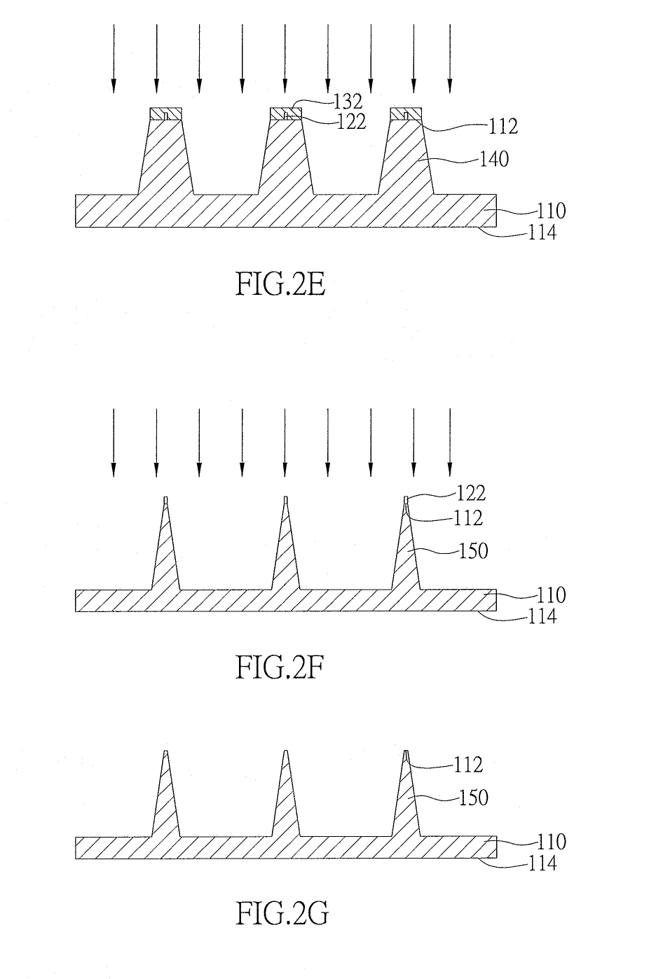

FIGS. 2A to 2G show a knife mold formed by a method of a first embodiment according to the present invention. As shown in FIG. 2A, the knife mold has a metal board 110 made of carbon steel. The metal board 110 comprises a first surface 112 for forming a blade and a second surface 114 opposite to the first surface 112. A roller applies ink to the first surface 112 of the metal board 110 so as to form a first corrosion-resistant photoresist layer 120 thereon. The first corrosion-resistant photoresist layer 120 is exposed and developed, with a negative having a specific pattern or letter, to form a patterned first line 122 that has a width equal to a desired knife edge, as shown in FIG. 2B. Iterate the above steps, as shown in FIG. 2C, to form on the first surface 112 of the metal board 110 a second corrosion-resistant photoresist layer 130 for covering the first line 122. As shown in FIG. 2D, the second corrosion-resistant photoresist layer 130 is exposed and developed to form on the first surface 112 of the metal board 110 a patterned second line 132 that encloses the first line 122. In the first embodiment of the present invention, two corrosion-resistant photoresist layers are used, and the first line 122 that has a width equal to the knife edge and the second line 132 that has a width slightly greater than the knife edge and encloses the first line 122 are formed sequentially. As shown in FIG. 2E, an etchant is sprayed toward the first surface 112 of the metal board 110. A blade prototype 140 of the knife mold is formed, with the pattern or letter width of the second line 132 as an etching mold. As shown in FIG. 2F, after the etchant has been continuously sprayed for a period of time, the second line 132 on the first surface 112 of the metal board 110 is collapsed gradually due to the spraying of the etchant and side-etch, to thereby expose the first line 122 otherwise enclosed by the second line 132 and, thereupon, form a well-defined blade 150 of the knife mold using the pattern or letter width of the first line 122 as an etching blade. Finally, as shown in FIG. 2G, the first and second corrosion-resistant photoresist layers 120 and 130 are removed from the first surface 112 of the metal board 110 to form the knife mold with a well-defined blade.

According to the first embodiment of the present invention, the knife mold includes a knife mold stand and the blade 150. In the first embodiment of the present invention, the knife mold no longer needs to be polished (mechanical polishing or CNC polishing) after the blade 150 is formed by etching once, and the blade 150 does not need to be etched a second time after the first and second corrosion-resistant photoresist layers 120 and 130 are removed. In the first embodiment of the present invention, the blade 150 of the knife mold is as high as 0.5 centimeter, preferably over 0.7 centimeter. The metallic raw material from which a top end 112 of the blade 150 is made remains intact. The blade 150 is of a uniform height. Therefore, the conforming rate of the knife mold is increased.

### Second Embodiment

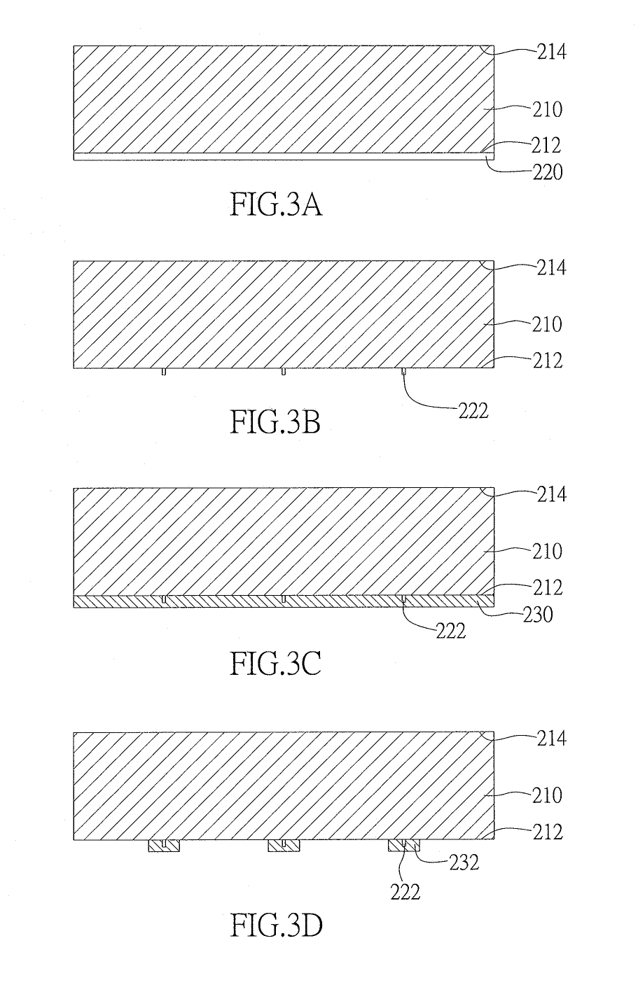

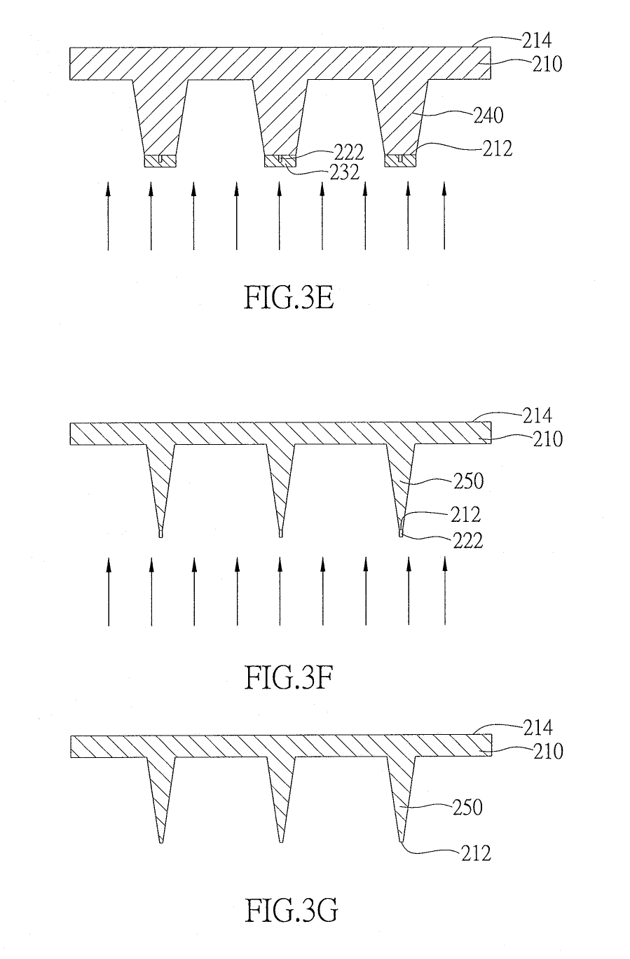

FIGS. 3A to 3G show a knife mold formed by a method of a second embodiment according to the present invention. As shown in FIG. 3A, a metal board 210 made of carbon steel comprises a first surface 212 for forming a blade and a second surface 214 opposite to the first surface 212. A first corrosion-resistant photoresist layer 220 is formed on the first surface 212 of the metal board 210 by a spin coating technique. The first corrosion-resistant photoresist layer 220 is exposed and developed, with a negative having a pattern or letter, to form on the first surface 212 of the metal board 210 a patterned first line 222 having a width equal to a desired knife edge, as shown in FIG. 3B. Iterate the above steps, as shown in FIG. 3C, to form on the first surface 212 of the metal board 210 a second corrosion-resistant photoresist layer 230 for enclosing the first line 222. As shown in FIG. 3D, the second corrosion-resistant photoresist layer 230 is exposed and developed, to form on the first surface 212 of the metal board 210 a patterned second line 232 for enclosing the first line 222.

As shown in FIG. 3E, the metal board 210 is etched with the first surface 212 facing down. Accordingly, when the etchant is sprayed upward and toward the first surface 212 of the metal board, the pattern or letter width of the second line 232 is taken as an etching mold, for forming a blade prototype 240 of the knife mold. As shown in FIG. 3F, after the etchant has been continuously sprayed for a period of time, the second line 232 on the first surface 212 of the metal board 210 is collapsed gradually due to the spraying of the etchant, to thereby expose the first line 222 otherwise enclosed by the second line 232 and, thereupon, form a well-defined blade 250 of the knife mold using the pattern or letter width of the first line 222 as an etching blade. Finally, as shown in FIG. 3G, the first and second corrosion-resistant photoresist layers 220 and 230 are removed, such that a knife mold with a well-defined blade is formed.

In the second embodiment of the present invention, the metal board 210 is etched with the first surface 212 facing down. Accordingly, the etchant is sprayed upward and toward the first surface 212 of the metal board 210. Therefore, the water resistance effect due to the residual etchant is avoided, and the knife mold with a well-defined blade is formed by etching once. Furthermore, the blade formed by the etching of the two corrosion-resistant photoresist layers features a reduced knife edge tolerance of between 0.05 and 0.15 centimeter, preferably between 0.08 and 0.12 centimeter.

### Third Embodiment

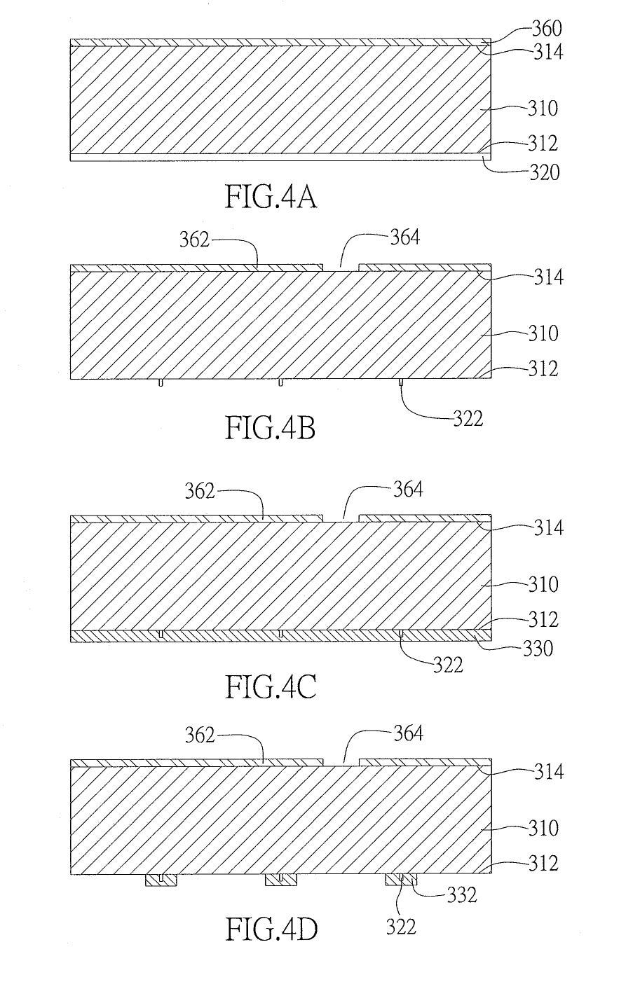

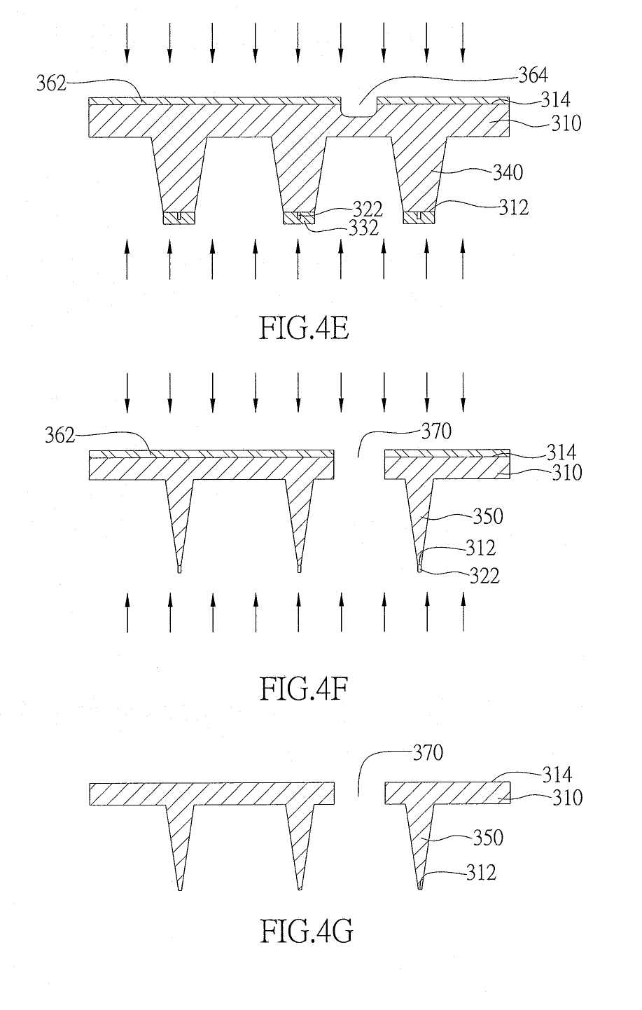

FIGS. 4A to 4G show a knife mold formed by a method of a third embodiment according to the present invention. As shown in FIG. 4A, a metal board 310 made of carbon steel comprises a first surface 312 for forming a blade and a second surface 314 opposite to the first surface 312. A first corrosion-resistant photoresist layer 320 and a third corrosion-resistant photoresist layer 360 are formed by a spin coating technique on the first surface 312 and the second surface 314 of the metal board 310, respectively. The first and third corrosion-resistant photoresist layers 320 and 360 are exposed and developed, with a negative having a pattern or letter, to form on the first and second surfaces 312 and 314 of the metal board 310 a patterned first line 322 that has a width equal to a desired knife edge and a patterned third line 362 having an opening 364 corresponding to a desired through hole, respectively, as shown in FIG. 4B. Iterate the above steps, as shown in FIG. 4C, a second corrosion-resistant photoresist layer 330 that covers the first line 322 is formed on the first surface 312 of the metal board 310. As shown in FIG. 4D, the second corrosion-resistant photoresist layer 330 is exposed and developed, to form on the first surface 312 of the metal board 310 a patterned second line 332 for enclosing the first line 322.

As shown in FIG. 4E, the etchant is sprayed upward and toward the first surface 312 of the metal board 310 and is sprayed downward and toward the second surface 314 of the metal board 310, simultaneously, with the pattern or letter width of the second line 332 as an etching mold, so as to form a blade prototype 340 of the knife mold. As shown in FIG. 4F, after the etchant has been continuously sprayed for a period of time, the second line 332 on the first surface 312 of the metal board 310 is collapsed gradually due to the spraying of the etchant, to thereby expose the first line 322 otherwise enclosed by the second line 332 and, thereupon, form a well-defined blade 350 of the knife mold using the pattern or letter width of the first line 322 as an etching blade. On the other hand, spraying the etchant toward the second surface 314 of the metal board 310 involves using the third line 362 as an etching mold, and a through hole 370 corresponding in position to an opening 364 of the third line 362 is formed in the knife mold. As shown in FIG. 4G, the corrosion-resistant photoresist layers on the first and second surfaces 312 and 314 of the metal board 310 are removed, such that the knife mold with the well-defined blade 350 and through hole 370 is formed.

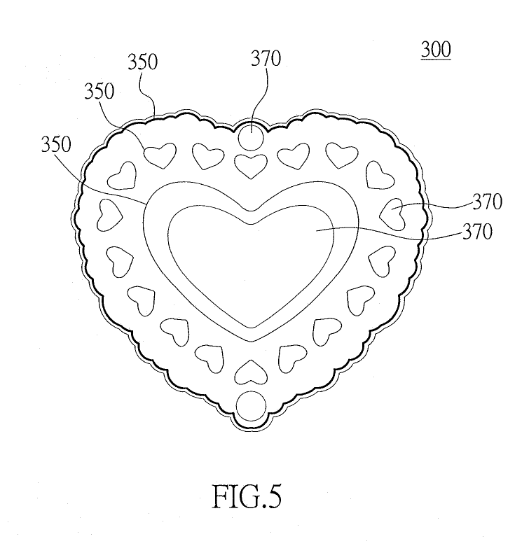

FIG. 5 is a top view of a knife mold 300 formed by the method of the third embodiment according to the present invention. The first and second corrosion-resistant photoresist layers are formed on the first surface of the metal board that is for forming the blade, the third corrosion-resistant photoresist layer is formed on the second surface of the metal board that is opposite to the first surface, and a three-D knife mold with the well-defined blade 350 and the through hole 370 readily releasable from the knife mold is formed, by etching once.

### Fourth Embodiment

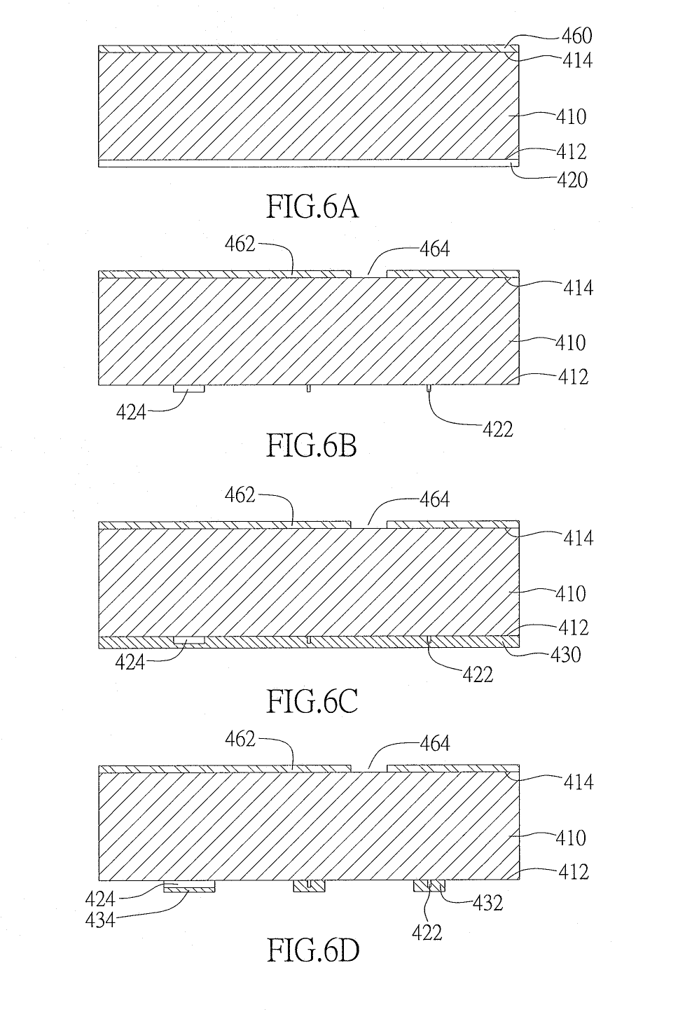

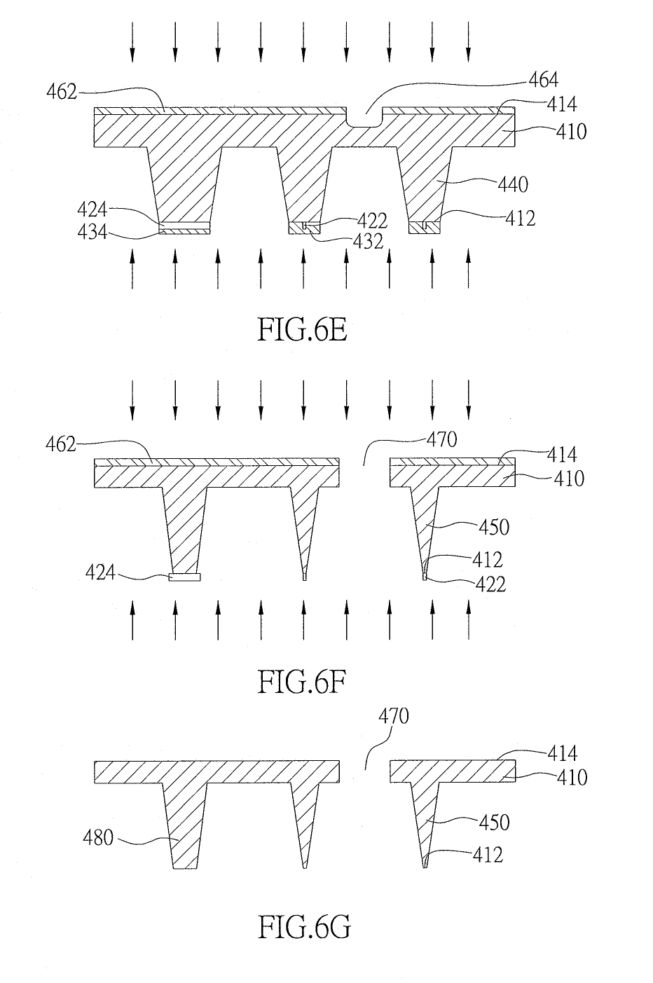

FIGS. 6A to 6G show a knife mold formed by a method of a fourth embodiment according to the present invention. As shown in FIG. 6A, a metal board 410 made of carbon steel comprises a first surface 412 for forming a blade and a second surface 414 opposite to the first surface 412. A first corrosion-resistant photoresist layer 420 and a third corrosion-resistant photoresist layer 460 are formed by a spin coating technique on the first and second surfaces 412 and 414 of the metal board 410, respectively. The first and third corrosion-resistant photoresist layers 420 and 460 are exposed and developed, to form on the first surface 412 of the metal board 410 a patterned first line 422 that has a width equal to a desired knife edge, and a patterned first line 424 that has a width equal to a desired protrusion portion. A patterned third line 462 that has an opening 464 corresponding to a desired through hole is formed on the second surface 412 of the metal board 410, as shown in FIG. 6B. Iterate the above steps, as shown in FIG. 6C, a second corrosion-resistant photoresist layer 430 that covers the first line 422 is formed on the first surface 412 of the metal board 410. As shown in FIG. 6D, the second corrosion-resistant photoresist layer 430 is exposed and developed, to form on the first surface 412 of the metal board 410 a patterned second line 432 for enclosing the first line 422 and a patterned second line 434 of the same width as the first line 424.

As shown in FIG. 6E, the etchant is sprayed upward and toward the first surface 412 of the metal board 410 and is sprayed downward and toward the second surface 414 of the metal board 410, simultaneously. The first surface 412 of the metal board 410 uses the patterns or letter widths of the second lines 432 and 434 as etching molds, to form a blade prototype 440 of the knife mold. As shown in FIG. 6F, after the etchant has been continuously sprayed for a period of time, the second lines 432 and 434 on the first surface 412 of the metal board 410 are collapsed gradually due to the spraying of the etchant, to thereby expose the first line 422 otherwise enclosed by the second line 432 and the first line 424 otherwise covered by the second line 434 and, thereupon, form a well-defined blade 450 and a protrusion portion 480 of the knife mold using the patterns or letter widths of the first lines 422 and 424 as an etching blade. On the other hand, the second surface 414 of the metal board 410 uses the third line 462 as an etching mold, and a through hole 470 of the knife mold is formed according to an opening 464 of the third line 462. As shown in FIG. 6G, the corrosion-resistant photoresist layers on the first and second surfaces 412 and 414 of the metal board 410 are removed, such that the knife mold with the well-defined blade 450, through hole 470 and protrusion portion 480 is formed.

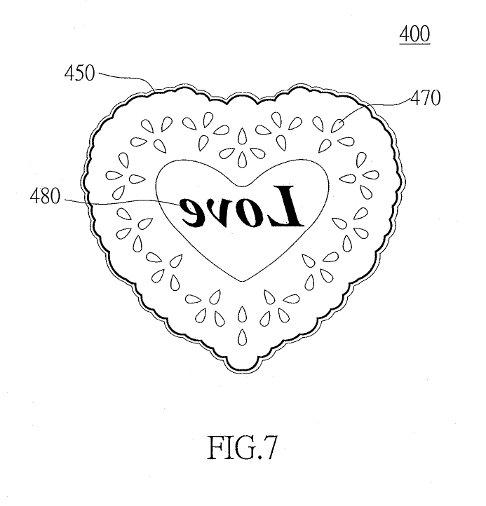

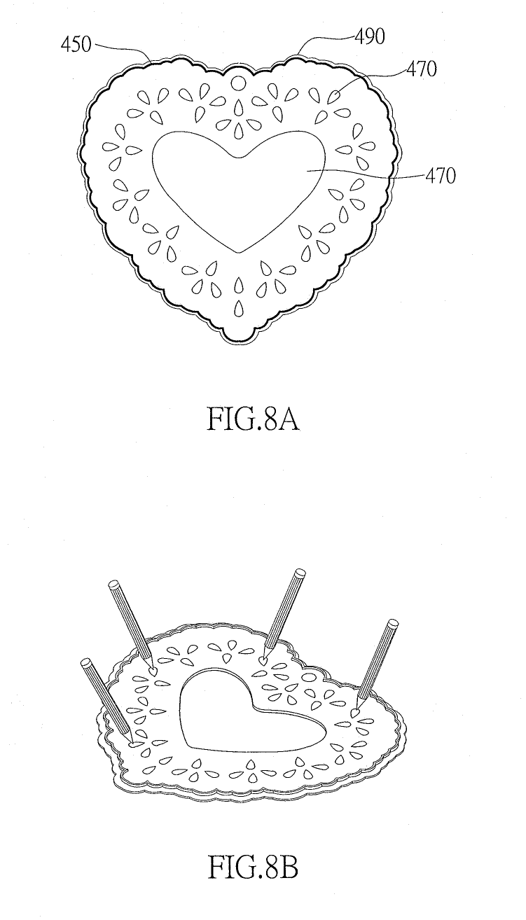

FIG. 7 is a top view of a knife mold 400 formed by the method of the fourth embodiment according to the present invention. In an embodiment according to the present invention, a three-D knife mold with the well-defined blade 450, the through hole 470 readily releasable from the knife mold, and the protrusion portion 480 that may be used for an impression embossment can be formed, by etching once. As shown in FIG. 8A, since the corrosion-resistant photoresist layers on both surfaces of the metal board are etched simultaneously, the blade 450 may be formed at the same time as the formation of the through hole 470, and an external form 490 of the knife mold stand may be cut simultaneously, such that the formed three-D knife mold may be further used as a drawing board, as shown in FIG. 8B.

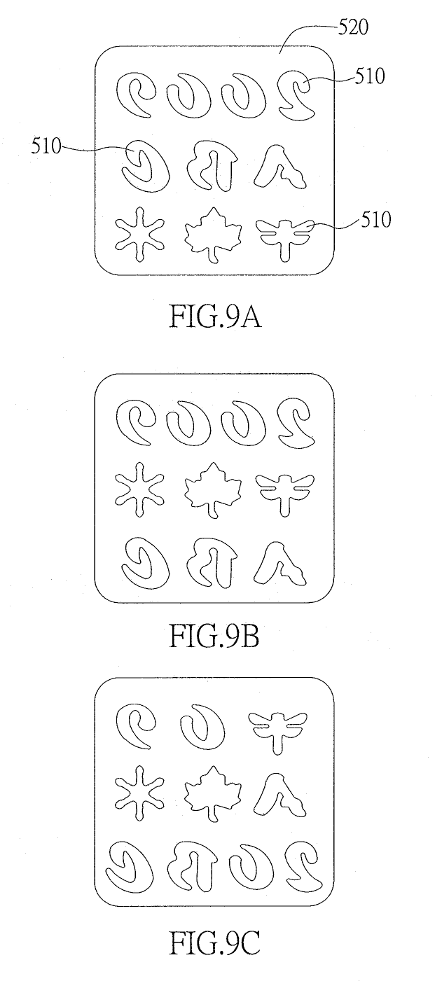

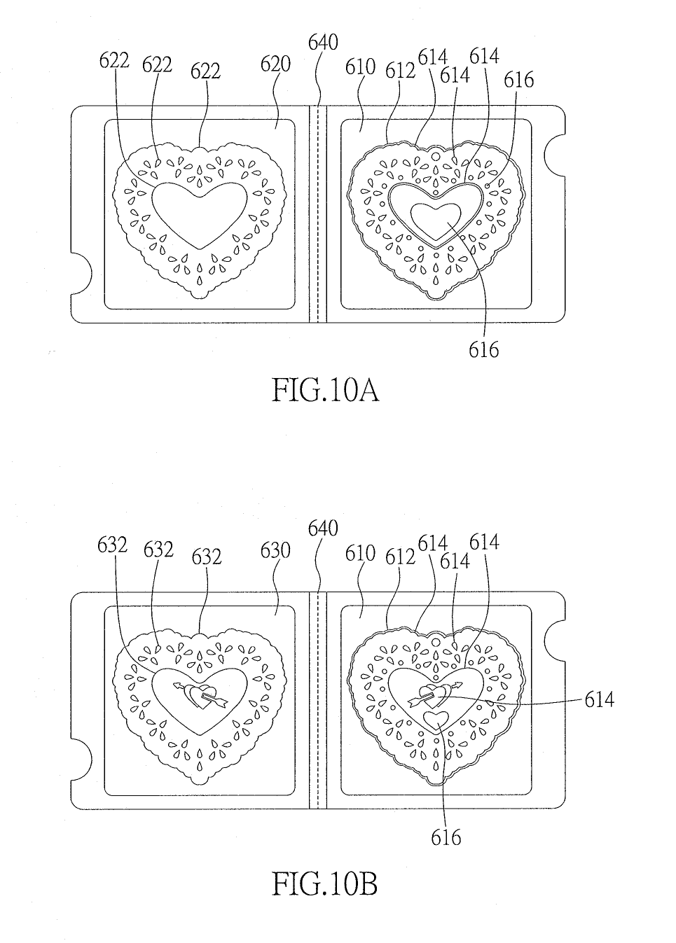

FIG. 9A shows a knife mold set configured to be displaceable and reassembable and formed by a method according to the present invention. The knife mold set comprises a plurality of small knife mold sets 510 and a soft magnetic sheet 520. A user is allowed to arrange a variety of letters or patterns at his will, as shown in FIGS. 9B and 9C. As shown in FIGS. 10A and 10B, a three-D knife mold board 610 formed by a method according to the present invention may cooperate with a concave board that is softer than the metal board of the knife mold. In an embodiment of the present invention, the concave board is a plastic concave board 620 or an aluminum concave board 630, which are stuck to a foldable plastic board 640, respectively, to form a three-D knife mold set. The concave boards 620 and 630 have concave slots 622 and 632 corresponding in position to the protrusion portion 614 of the three-D knife mold board 610, and does not have any concave slot corresponding in position to the blade 612 of the three-D knife mold board 610, allowing the user to impress embossment three-D patterns while cutting paper.

The foregoing descriptions of the detailed embodiments are illustrated to disclose the features and functions of the present invention but are not restrictive of the scope of the present invention. It should be understandable to those skilled in the art that all modifications and variations made to the embodiments of the present invention according to the spirit and principle in the disclosure of the present invention should fall within the scope set forth in the appended claims.

What is claimed is:

1. A method of forming a knife mold by etching once, comprising the steps of:
(A) providing a metal board having a first surface for forming a blade and a second surface opposite to the first surface;
(B) forming a first corrosion-resistant photoresist layer on the first surface of the metal board, and exposing and developing the first corrosion-resistant photoresist layer, to form a patterned first line on the first surface;
(C) forming on the first surface of the metal board a second corrosion-resistant photoresist layer for covering the first line, and forming on the second corrosion-resistant photoresist layer a patterned second line for enclosing the first line;
(D) spraying an etchant toward the first surface of the metal board to etch the first surface of the metal board, so as to form the blade; and
(E) removing the first corrosion-resistant photoresist layer and the second corrosion-resistant photoresist layer from the metal board.

2. The method of claim 1, wherein the metal board is etched with the first surface facing down.

3. The method of claim 1, wherein the first surface of the metal board is degreased and defatted prior to the formation of the first corrosion-resistant photoresist layer.

4. The method of claim 1, wherein an antioxidation process is performed on the first surface of the metal board after the first and second corrosion-resistant photoresist layers are removed therefrom.

5. The method of claim 1, wherein the step (B) further comprises:
forming a third corrosion-resistant photoresist layer on the second surface of the metal board, and exposing and developing the third corrosion-resistant photoresist layer, to form a patterned third line on the second surface.

6. The method of claim 5, wherein the third corrosion-resistant photoresist layer is formed on the second surface of the metal board at the same time as the formation of the first corrosion-resistant photoresist layer on the first surface of the metal board.

7. The method of claim 5, wherein the step (D) further comprises spraying the etchant toward the second surface of the metal board to etch the second surface of the metal board, so as to form a through hole.

8. The method of claim 7, wherein the first surface and the second surface of the metal board are etched simultaneously.

9. The method of claim 5, wherein the step (E) further comprises removing the third corrosion-resistant photoresist layer from the second surface of the metal board.

10. The method of claim 9, wherein the corrosion-resistant photoresist layers on the first and second surfaces of the metal board are removed simultaneously.

11. A knife mold formed by the method of claim 1, comprising:
a knife mold stand; and
a blade formed on the knife mold stand, wherein a surface of a top end of the blade is made of the same metal as the knife mold stand and has the same pattern as a surface of the knife mold stand.

12. The knife mold of claim 11, wherein the blade has a knife edge tolerance of between 0.05 and 0.15 centimeter.

13. The knife mold of claim 11, wherein the knife mold stand is formed with a through hole.

14. The knife mold of claim 11, wherein the knife mold stand is formed with a protrusion portion.

15. A knife mold set configured to be displaceable and reassembable, comprising at least a knife mold formed by the method of claim 1, and a soft magnetic sheet.

16. A knife mold set, comprising:
a three-D knife mold board formed by the method of claim 1 and having a blade and a protrusion portion;
a concave board corresponding to the knife mold board and having a concave slot corresponding in position to the protrusion portion of the knife mold; and
a foldable plastic board for sticking the knife mold board to the concave board.

17. The knife mold set of claim 16, wherein the concave board is formed of a material softer than a material of the knife mold board.

18. The knife mold set of claim 16, wherein the concave board is made of aluminum or plastic.
